(19) United States
(12) Patent Application Publication
(10) Pub. No.: US 2024/0359410 A1
(43) Pub. Date: Oct. 31, 2024

(54) ELECTROFUSION TOOL

(71) Applicant: MILWAUKEE ELECTRIC TOOL CORPORATION, Brookfield, WI (US)

(72) Inventors: Jacob K. Lindsey, Milwaukee, WI (US); Justin Miller, Richfield, WI (US); Ka Seng Lim, Milwaukee, WI (US); Andrew F. Troy, Chicago, IL (US); Peter J. Davies, Milwaukee, WI (US); Matthew R. Wolf, Wauwatosa, WI (US); Keegan P. Fager, Waukesha, WI (US); Troy C. Thorson, Cedarburg, WI (US)

(21) Appl. No.: 18/646,373

(22) Filed: Apr. 25, 2024

Related U.S. Application Data
(60) Provisional application No. 63/464,336, filed on May 5, 2023.
(60) Provisional application No. 63/461,717, filed on Apr. 25, 2023.

(51) Int. Cl. B29C 65/30; B29C 65/00

(52) U.S. Cl. CPC B29C 65/30; B29C 66/522

(57) ABSTRACT

A universal tip for an electrofusion tool including a main body configured to be electrically connected to an electrical lead of the electrofusion tool, and a contact supported by the main body being capable of transferring a voltage from the electrofusion tool to a pipe fitting. The contact is adjustable between a first configuration, in which the contact is configured to engage a first terminal having a first size, and a second configuration, in which the contact is configured to engage a second terminal having a second size that is different than the first size.

### CROSS-REFERENCE TO RELATED APPLICATIONS

This application claims priority to U.S. Provisional Patent Application No. 63/461,717, filed on Apr. 25, 2023, and U.S. Provisional Patent Application No. 63/464,336, filed on May 5, 2023, the entire contents of both of which are incorporated by reference herein.

### FIELD OF THE INVENTION

The present invention relates to power tools, and more specifically, an electrofusion power tool.

### BACKGROUND OF THE INVENTION

Pipe fusion uses heat to join two segments of polyethylene pipe together permanently. In electrofusion, the two pipes to be connected are inserted into a one-time fitting. Then, a predetermined voltage is applied to the terminals of the fitting to heat the inside of the fitting. This melts the pipes to make a type of weld connection.

### SUMMARY OF THE INVENTION

In one aspect, the invention provides a universal tip for an electrofusion tool including a main body configured to be electrically connected to an electrical lead of the electrofusion tool, and a contact supported by the main body being capable of transferring a voltage from the electrofusion tool to a pipe fitting. The contact is adjustable between a first configuration, in which the contact is configured to engage a first terminal having a first size, and a second configuration, in which the contact is configured to engage a second terminal having a second size that is different than the first size.

Other aspects of the invention will become apparent by consideration of the detailed description and accompanying drawings.

### BRIEF DESCRIPTION OF THE DRAWINGS

FIG. 1 is a perspective view of an electrofusion tool in accordance with an embodiment of the invention, illustrating electrical leads electrically connectable to a pipe fitting.

FIG. 2 is a perspective view of the pipe fitting that may receive two separate PVC pipes, illustrating electrical terminals that electrically connect to the electrical leads of the electrofusion tool.

FIG. 3 is a perspective view of the electrofusion tool of FIG. 1, illustrating a depleted battery pack being removed from the electrofusion tool and a new, fully charged battery pack from a battery charger being installed in the electrofusion tool.

FIG. 4 is a universal tip of the electrical leads in accordance with an embodiment of the invention.

FIG. 5 is a universal tip of the electrical leads in accordance with another embodiment of the invention.

FIG. 6 is a universal tip of the electrical leads in accordance with yet another embodiment of the invention.

FIG. 7 is a universal tip of the electrical leads in accordance with still yet another embodiment of the invention.

FIG. 8 is a universal tip of the electrical leads in accordance with still yet another embodiment of the invention.

FIG. 9 is a universal tip of the electrical leads in accordance with still yet another embodiment of the invention.

FIG. 10 is a universal tip of the electrical leads in accordance with still yet another embodiment of the invention.

FIG. 11 is a universal tip of the electrical leads in accordance with still yet another embodiment of the invention.

FIG. 12 is a universal tip of the electrical leads in accordance with still yet another embodiment of the invention.

FIG. 13 is a universal tip of the electrical leads in accordance with still yet another embodiment of the invention.

FIG. 14 is a universal tip of the electrical leads in accordance with still yet another embodiment of the invention.

FIG. 15 is a universal tip of the electrical leads in accordance with still yet another embodiment of the invention.

FIG. 16 is a universal tip of the electrical leads in accordance with still yet another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

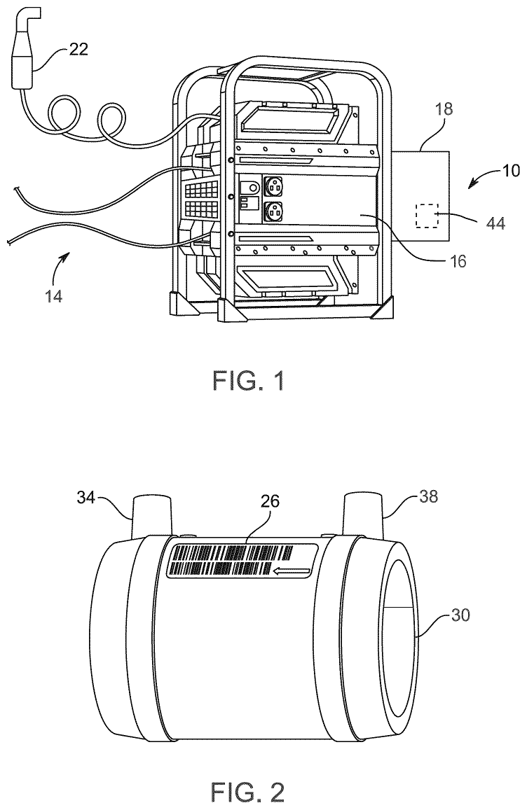

FIG. 1 illustrates a battery-operated electrofusion tool 10. The electrofusion tool 10 includes a pair of electrical leads 14 extending from the electrofusion tool 10 and a battery pack 18 that is selectively coupled to a power module 16 of the electrofusion tool 10. The battery pack 18 provides power to the electrofusion tool 10 and voltage across the electrical leads 14 through the power module 16. In other embodiments, the electrofusion tool 10 may be powered from a wall outlet or other suitable power source. A scanner 22 is connected to the electrofusion tool 10 for scanning a barcode 26 containing the pipe fitting characteristics (e.g., voltage required, voltage time, curing time, etc.) of the pipe fitting 30.

With reference to FIGS. 1 and 2, during a fusion process, a user peels the outer layer of plastic from the PVC pipe to make a clean connection. Next, the PVC pipes are inserted into the pipe fitting 30 and clamped to stabilize the PVC pipes. Subsequently, the electrofusion tool 10 is turned on and the electrical leads 14 (e.g., red positive lead to positive terminal 34 on the pipe fitting 30, black negative lead to negative terminal 38 on the pipe fitting 30) are connected to the pipe fitting 30. Using the scanner 22, the user scans the barcode 26 on the pipe fitting 30 where the power module 16 of the electrofusion tool 10 collects the pipe fitting characteristics. At this point, the power module 16 begins supplying voltage to the electrical leads 14 from the battery 18 in accordance with the pipe fitting characteristics. The voltage traveling through the terminals 34, 38 of the pipe fitting 30 heat a heat conductive coil within the pipe fitting 30, which melts at least portions of the pipe fitting 30 and/or the PVC pipes to couple the components together. Finally, the electrical leads 14 are removed from the pipe fitting 30 and the PVC joints are permanently joined together.

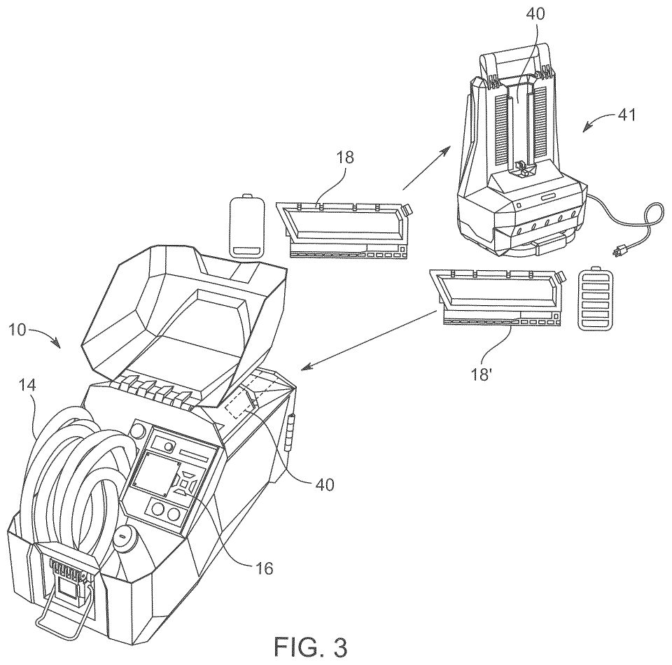

As previously mentioned, the electrofusion tool 10 may selectively receive the battery pack 18. With reference to FIG. 3, the battery pack 18 may be a power tool battery pack generally used to power a power tool, such as drills, electric saws, and the like (e.g., an 18-volt, 24-volt, 36-volt, 72-volt rechargeable battery pack, etc.). Specifically, the illustrated battery pack 18 is a high power battery pack having a nominal voltage of up to about 80V. The battery pack 18 may include lithium ion (Li-ion) cells that are operable to output a sustained operating discharge current of between about 40 A and about 60 A. In alternate embodiments, the battery pack 18 may be of a different chemistry (e.g., nickel-cadmium (NiCa or NiCad), nickel-hydride, and the like).

The battery pack 18 may further include terminals (not shown) to connect to a battery connector 40 of the power module 16 or a battery charger 41. The terminals for the battery pack 18 include a positive terminal and a negative terminal to provide power to and from the battery pack 18. In some embodiments, the battery pack 18 further includes a temperature terminal to monitor the temperature of the battery pack 18, the power module 16, or the battery charger 41. In some embodiments, the battery pack 18 also includes data terminals to communicate with the electrofusion tool 10. For example, in alternate embodiments, the battery pack 18 may include a microcontroller 44 that monitors characteristics of the battery pack 18, such as the state of charge of the battery pack 18, the temperature of the battery pack 18, or other characteristics relevant to the battery pack 18. The microcontroller 44 may send signals to the power module 16 indicating various characteristics of the battery pack 18, at which point the power module 16 may regulate the electrofusion tool 10 accordingly. In alternate embodiments, the microcontroller 44 may also control aspects of charging and/or discharging of the battery pack 18. In some embodiments, the battery connector 40 may include the data terminals for communicating with the battery pack 18.

As shown in FIG. 3, when the charge of the battery pack 18 is depleted, the battery pack 18 can be removed and placed on the battery charger 41 to charge while a new battery pack 18′ that is fully charged is installed in the electrofusion tool 10. That is, the electrofusion tool 10 may receive the battery packs 18, 18′ interchangeably.

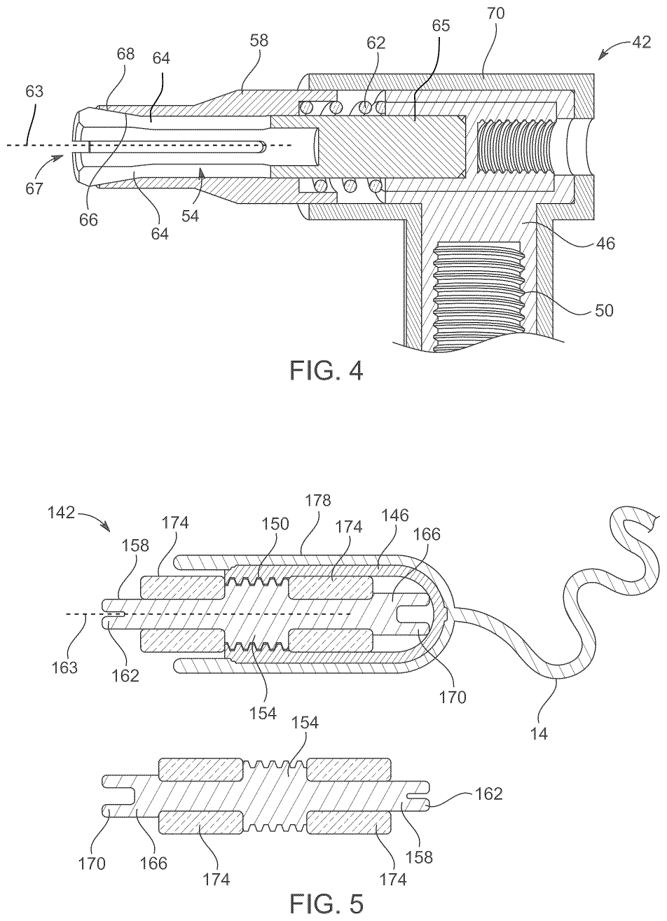

With reference to FIG. 2, the pipe fitting 30 comes in different sizes to accommodate different size pipe ends of the PVC pipes. As such, different pipe fittings often include different voltage platforms, which often change the size and shape of the positive and negative terminals 34, 38 of the pipe fitting 30. Specifically, the terminals 34, 38 can vary in size from 4.0 millimeters to 4.7 millimeters in diameter. Therefore, a universal tip 42 (FIG. 4) is coupled to each end of the electrical leads 14 to accommodate different sized terminals 34, 38, as explained in further detail below.

With reference to FIG. 4, the universal tip 42 includes a main body 46 having a threaded aperture 50 to threadably and electrically connect to one of the electrical leads 14. A similar universal tip may also be coupled to the other electrical lead 14. The universal tip 42 further includes a contact 54 in electrical communication with the main body 46, a collar 58 disposed around the contact 54, and a spring 62. The collar 58 is movable along an axis 63 between an extended position (as shown in FIG. 4), in which the collar 58 exerts a force on the contact 54, and a retracted position, in which the collar 58 no longer exerts a force on the contact 54. The spring 62 biases the collar 58 toward the extended position. When in the extended position, the collar 58 exerts a compression force on the contact 54 to elastically deform the contact 54 radially inward toward the terminals 34, 38. Specifically, the contact 54 includes a series of fingers 64 extending from a base 65. The series of fingers 64 are generally parallel to the axis 63 when no force is being exerted on the series of fingers 64 and skew radially inward when the collar 58 compresses the series of fingers 64. That is, the series of fingers 64 move radially inward toward the axis 63, such that the series of fingers 64 angularly skew relative to the axis 63, causing an opening 67 of the contact 54 to diametrically change sizes between a first size and a second size that is larger than the first size. When the opening 67 is the first size, a user may pull the collar 58 along the axis 63 toward the retracted position against the bias of the spring 62, allowing the contact 54 to rebound radially outward and increasing the opening 67 to the second size. The collar 58 includes a cam surface 66 that is responsible for moving the contact 54 radially inward and outward. Specifically, the cam surface 66 slides against a corresponding cam surface 68 of the contact 54, causing radial movement of the series of fingers 64 simultaneously. The collar 58 is preferably composed of an electrically insulative material to avoid inadvertent electrocution. Similarly, the universal tip 42 also includes an outer coating 78 that is composed of an electrically insulative material and encases the main body 46. In the illustrated embodiment, the contact 54 is composed of brass, while in other embodiments, the contact 54 may alternatively be composed of other suitable electrically conductive materials.

FIG. 5 illustrates another universal tip 142 that can be coupled to each of the electrical leads 14 to accommodate different sized terminals 34, 38. The universal tip 142 includes a main body 146 that is electrically connected to one of the electrical leads 14. A similar universal tip may also be coupled to the other electrical lead 14. The main body 146 includes a threaded aperture 150 to which a contact 154 is threadably and electrically connected along an axis 163. The contact 154 includes a first end 158 having a first contact portion 162 and a second end 166 opposite the first end 158 and having a second contact portion 170. The first contact portion 162 is smaller than the second contact portion 170. Specifically, the first contact portion 162 is capable of receiving the 4.0 millimeter terminals 34, 38, while the second contact portion 170 is capable of receiving the 4.7 millimeter terminals 34, 38. A user may unthread the contact 154 from the main body 146 and rethread the contact 154 to the main body 146 along the axis 163 with either contact portion 162, 170 being external to the main body 146. That is, either the first contact portion 162 or the second contact portion 170 faces outward to engage the terminals 34, 38. For example, when the first contact portion 162 faces outward, the universal tip 142 is ready to receive the 4.0 millimeter terminals 34, 38. In this position, the second contact portion 170 is not accessible and disposed within the main body 146. When the second contact portion 170 faces outward, the universal tip 142 is ready to receive the 4.7 millimeter terminals 34, 38. In this position, the first contact portion 162 is not accessible and disposed within the main body 146. An insulative material 174 may wrap around the contact 154 for a user to grip when screwing and unscrewing the contact 154 from the main body 146. Similarly, the universal tip 142 also includes an outer coating 178 that is composed of an electrically insulative material and encases the main body 146. The contact 154 is composed of brass, while in other embodiments, the contact 54 may alternatively be composed of other suitable electrically conductive materials.

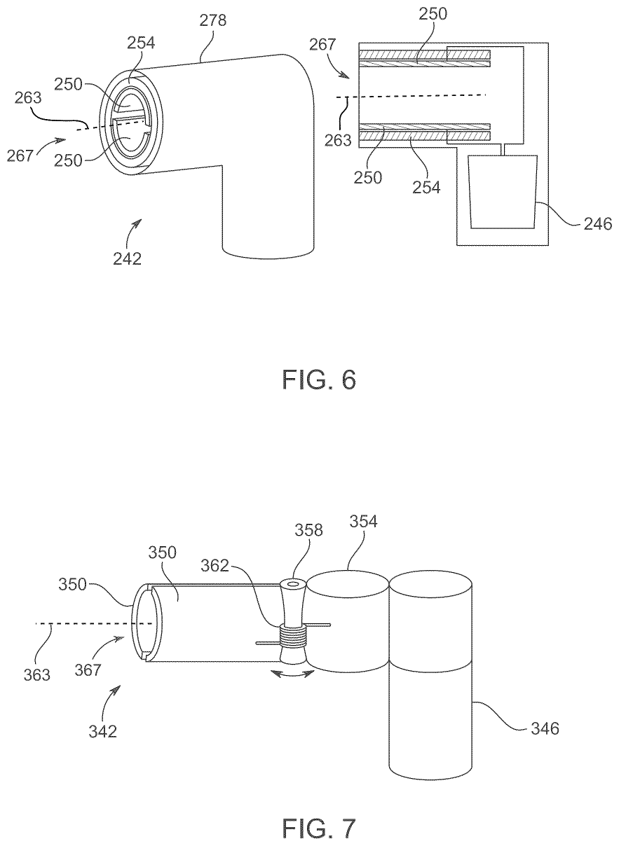

FIG. 6 illustrates another universal tip 242 that can be coupled to each of the electrical leads 14 to accommodate different sized terminals 34, 38. The universal tip 242 includes a main body 246 that is electrically connected to one of the electrical leads 14, a series of arcuate plates 250 coupled to the main body 246, an axis 263 about which the arcuate plates 250 are disposed, an opening 267 between the series of arcuate plates 250, and a, elastomeric sleeve 254 disposed around the series of plates 250. A similar universal tip may also be coupled to the other electrical lead 14. The series of arcuate plates 250 is electrically connected to the main body 246 and biased radially inward toward the axis 263 by the elastomeric sleeve 254, such that the opening 267 is a first size. When a user engages the universal tip 242 with the terminals 34, 38, the terminals 34, 38 mechanically interfere with the arcuate plates 250 and exert a force on the arcuate plates 250, causing the plates 250 to move radially outward relative to the axis 263 against the bias of the elastomeric sleeve 254. As such, the opening 267 changes to a second size larger than the first size. In the illustrated embodiment, the series of arcuate plates 250 includes two plates. In other embodiments, the series of arcuate plates 250 may include two or more individual plates. The universal tip 242 also includes an outer coating 278 that is composed of an electrically insulative material and encases the main body 146. The series of arcuate plates 250 are composed of brass, while in other embodiments, the series of plates 250 may alternatively be composed of other suitable electrically conductive materials.

FIG. 7 illustrates another universal tip 342 that can be coupled to each of the electrical leads 14 to accommodate different sized terminals 34, 38. The universal tip 342 includes a main body 346 that is electrically connected to one of the electrical leads 14, a series of arcuate plates 350, an axis 363 about which the arcuate plates 350 are disposed, an opening 367 between the series of arcuate plates 350, a handle portion 354, and a pivot 358 disposed between the arcuate plates 350 and the handle portion 354. A similar universal tip may also be coupled to the other electrical lead 14. The pivot 358 includes a torsion spring 362 that biases the arcuate plates 350 toward each other, such that the opening 367 is a first size. A user may squeeze (i.e., pinch) the handle portion 354 against the bias of the spring 362 to move the arcuate plates 350 away from each other, such that the opening 367 is a second size larger than the first size. As such, a user pinches the handle portion 354 to move the arcuate plates 350 away from the axis 363, at which point the arcuate plates 350 may clamp down on the terminals 34, 38 of different sizes when a user releases the handle portion 354. The universal tip 342 also includes an outer coating 378 that is composed of an electrically insulative material and encases the handle portion 354 and at least an outer periphery of the arcuate plates 350. The series of arcuate plates 350 are composed of brass, while in other embodiments, the series of plates 350 may alternatively be composed of other suitable electrically conductive materials.

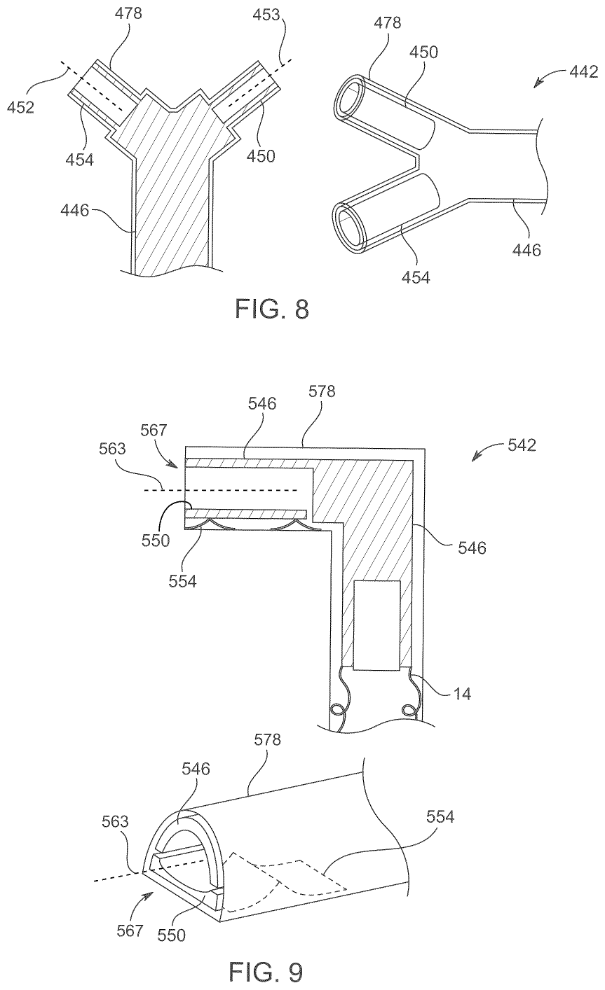

FIG. 8 illustrates another universal tip 442 that can be coupled to each of the electrical leads 14 to accommodate different sized terminals 34, 38. The universal tip 442 includes a main body 446 that is electrically connected to one of the electrical leads 14, a first contact 450 connected to the main body 446, and a second contact 454 connected to the main body 446. A similar universal tip may also be coupled to the other electrical lead 14. The main body 446 splits to form the first contact 450 that is separate from the second contact 454. The first contact 450 extends in a first direction along a first axis 452, while the second contact 454 extends in a second direction along a second axis 453 that is different from the first direction. In the illustrated embodiment, the first axis 452 and the second axis 453 are angled approximately 90 degrees relative to each other. In other embodiments, the first axis 452 and the second axis 453 may be angled more than 90 degrees relative to each other or less than 90 degrees relative to each other. For example, the first axis 452 and the second axis 453 may be angled between 30 degrees and 180 degrees relative to each other. The first contact 450 accommodates the 4.0 millimeter terminals 34, 38, while the second contact 454 accommodates the 4.7 millimeter terminals 34, 38. There may be another contact in some embodiments that extends in another direction different from the first and second directions. The universal tip 442 also includes an outer coating 478 that is composed of an electrically insulative material and encases the main body 446. The contacts 450, 454 are composed of brass, while in other embodiments, the contacts 450, 454 may alternatively be composed of other suitable electrically conductive materials.

FIG. 9 illustrates another universal tip 542 that can be coupled to each of the electrical leads 14 to accommodate different sized terminals 34, 38. The universal tip 542 includes a main body 546 that is electrically connected to one of the electrical leads 14, a plate 550 moveable relative to the main body 546, and a spring 554 (e.g., leaf spring, etc.) for biasing the plate 550 toward the main body 546. A similar universal tip may also be coupled to the other electrical lead 14. The universal tip 542 further includes an opening 567 between the plate 550 and the main body 546, and an axis 563 defined along the opening 567. The opening 567 is moveable between a first size and a second size that is larger than the first size. The spring 554 biases the plate 550, and therefore, the opening 567 to the first size. When a user places the universal tip 542 onto the terminals 34, 38, the terminals 34, 38 mechanically interfere with the plate 550 and exert a force on the plate 550, causing the plate 550 to move away from the main body 546 to the second size against the bias of the spring 554. As such, the plate 550 also moves away from the axis 563. The universal tip 542 also includes an outer coating 578 that is composed of an electrically insulative material and encases the main body 546. The main body 546 and the plate 550 are composed of brass, while in other embodiments, the main body 546 and the plate 550 may alternatively be composed of other suitable electrically conductive materials.

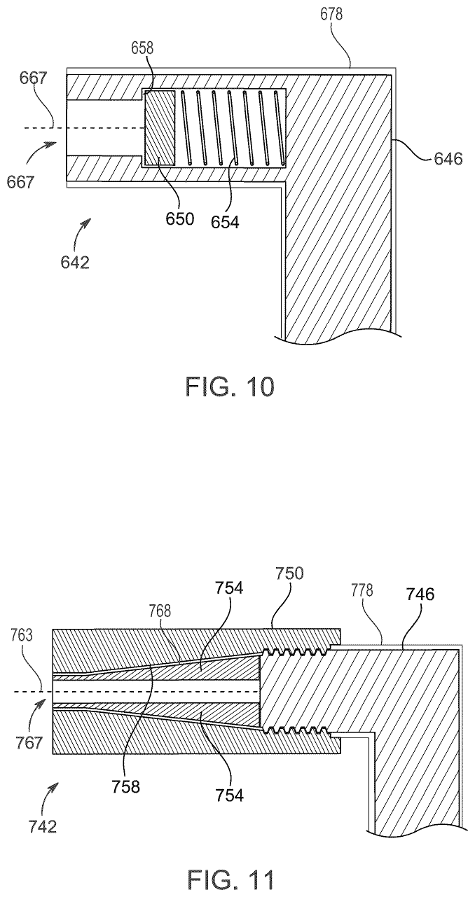

FIG. 10 illustrates another universal tip 642 that can be coupled to each of the electrical leads 14 to accommodate different sized terminals 34, 38. The universal tip 642 includes a main body 646 that is electrically connected to one of the electrical leads 14, a plate 650 moveable relative to the main body 646, and a spring 654 (e.g., compression spring, etc.) for biasing the plate 650 toward the terminals 34, 38. A similar universal tip may also be coupled to the other electrical lead 14. The universal tip 642 further includes an opening 667 through which the terminals 34, 48 may pass. The opening 667 defines an axis 663, along which the plate 650 moves. A shoulder 658 formed on an inner surface of the main body 646 inhibits the plate 650 from falling out of the opening 667. When a user places the universal tip 642 onto the terminals 34, 38, the terminals 34, 38 interface with and exert a force on the plate 650, causing the plate 650 to retract into the main body 646 along the axis 663 against the bias of the spring 654. The universal tip 642 remains on the terminals 34, 38 via a snug fit (e.g., press fit, etc.) between the universal tip 642 and the terminals 34, 38. The plate 650 is constantly biased toward the terminals 34, 38, such that the plate 650 remains in contact with the terminals 34, 38. The universal tip 642 also includes an outer coating 678 that is composed of an electrically insulative material and encases the main body 646. The plate 650 is composed of brass, while in other embodiments, the plate 650 may alternatively be composed of other suitable electrically conductive materials.

FIG. 11 illustrates another universal tip 742 that can be coupled to each of the electrical leads 14 to accommodate different sized terminals 34, 38. The universal tip 742 includes a main body 746 that is electrically connected to one of the electrical leads 14, a collar 750 threadably coupled to the main body 746, and contacts 754 disposed within the collar 750. A similar universal tip may also be coupled to the other electrical lead 14. The universal tip 742 further includes an opening 767 through which the terminals 34, 48 may pass. The opening 767 defines an axis 763, along which the collar 750 moves when rotated. The collar 750 includes a cam member 758 that interacts with a corresponding cam member 768 of the contacts 754 to move the contacts 754 radially inward and radially outward relative to the axis 763. A user may rotate the collar 750 relative to the main body 746, for example, clockwise to move the contactors 754 radially inward towards the terminals 34, 38 to change the opening 767 to a first size. Similarly, a user may rotate the collar 750 relative to the main body 746, for example, counterclockwise to move the contacts 754 radially outward away from the terminals 34, 38 to change the opening 767 to a second size that is larger than the first size. The universal tip 742 also includes an outer coating 778 that is composed of an electrically insulative material and encases the main body 746. The contacts 754 are composed of brass, while in other embodiments, the contacts 754 may alternatively be composed of other suitable electrically conductive materials.

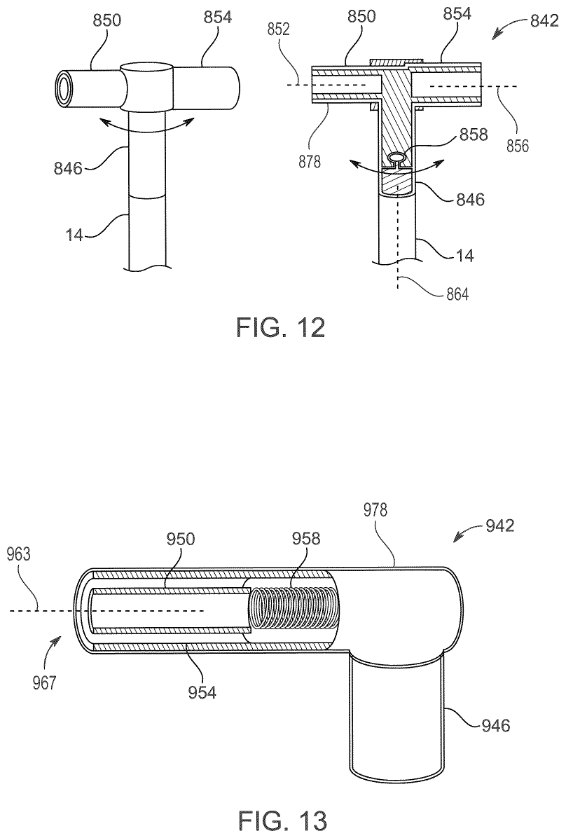

FIG. 12 illustrates another universal tip 842 that can be coupled to each of the electrical leads 14 to accommodate different sized terminals 34, 38. The universal tip 842 includes a main body 846 that is electrically connected to one of the electrical leads 14, a first contact 850 defining a first axis 852 and connected to the main body 846, and a second contact 854 defining a second axis 856 and connected to the main body 846. A similar universal tip may also be coupled to the other electrical lead 14. The first contact 850 extends in a first direction, while the second contact 854 extends in a second direction that is different from the first direction. Specifically, the first axis 852 of the first contact 850 is angularly spaced 180 degrees from the second axis 856 of the second contact 854. The first contact 850 accommodates the 4.0 millimeter terminals 34, 38, while the second contact 854 accommodates the 4.7 millimeter terminals 34, 38. The universal tip 842 remains on the terminals 34, 38 via a snug fit (e.g., press fit, etc.) between the universal tip 842 and the terminals 34, 38. A pivot joint 858 is disposed between the electrical leads 14 and the main body 846, such that the main body 846 may rotate relative to the electrical leads 14. Specifically, the main body 846 may rotate about a pivot axis 864 that is perpendicular to the first and second axis 852, 856. There may be another contact in some embodiments that extends in another direction different from the first and second directions. The universal tip 842 also includes an outer coating 878 that is composed of an electrically insulative material and encases the main body 846. The contacts 850, 854 is composed of brass, while in other embodiments, the contacts 850, 854 may alternatively be composed of other suitable electrically conductive materials.

FIG. 13 illustrates another universal tip 942 that can be coupled to each of the electrical leads 14 to accommodate different sized terminals 34, 38. The universal tip 942 includes a main body 946 that is electrically connected to one of the electrical leads 14, a first barrel 950 disposed within the main housing 946, and a second barrel 954 disposed within the main housing 946. A similar universal tip may also be coupled to the other electrical lead 14. The first barrel 950 is disposed within the second barrel 954. The universal tip 942 also includes an opening 967 that receives the terminals 34, 38. The opening 967 defines an axis 963, along which the first barrel 950 moves. A spring 958 is disposed within the second barrel 954 and biases the first barrel 950. The first barrel 950 accommodates the 4.0 millimeter terminals 34, 38, while the second barrel 954 accommodates the 4.7 millimeter terminals 34, 38. A user may engage the universal tip 942 with the 4.0 millimeter terminals 34, 38, causing the first barrel 950 to receive the 4.0 millimeter terminals 34, 38. When a user engages the universal tip 942 with the 4.7 millimeter terminals 34, 38, the terminals 34, 38 mechanically interfere with and exert a force on the first barrel 950, causing the first barrel 950 to move against the bias of the spring 958, at which point the second barrel 954 engages the 4.7 millimeter terminals 34, 38. Thus, the first barrel 950 moves rearward along the axis 963, which changes the opening 967 from a first size to a second size that is larger than the first size. The first barrel 950 is constantly biased toward the terminals 34, 38, such that the plate 950 remains in contact with the terminals 34, 38. The universal tip 942 also includes an outer coating 978 that is composed of an electrically insulative material and encases the main body 946. The first and second barrels 950, 954 are composed of brass, while in other embodiments, the first and second barrels 950, 954 may alternatively be composed of other suitable electrically conductive materials.

FIG. 14 illustrates another universal tip 1042 that can be coupled to each of the electrical leads 14 to accommodate different sized terminals 34, 38. The universal tip 1042 includes a main body 1046 that is electrically connected to one of the electrical leads 14 and a plurality of pins 1050 that are biased outward. A similar universal tip may also be coupled to the other electrical lead 14. The plurality of pins 1050 move axially inward and outward relative to each other along or parallel to an axis 1063. As the plurality of pins 1050 move inward along the axis 1063 via the terminals 34, 38 exerting a force on the pins 1050, an opening 1067 is created that accommodates the terminals 34, 38. The number of pins 1050 moving at one time depends on the size of the electrical terminals 34, 38. For example, a greater number of pins 1050 move axially inward along the axis 1063 when the 4.7 millimeter terminals 34, 38 are received within the main body 1046. Conversely, a fewer number of pins 1050 moves axially inward along the axis 1063 when the 4.0 millimeter terminals 34, 38 are received within the main body 1046. The universal tip 1042 also includes an outer coating 1078 that is composed of an electrically insulative material and encases the main body 1046. The plurality of pins 1050 are composed of brass, while in other embodiments, the plurality of pins 1050 may alternatively be composed of other suitable electrically conductive materials.

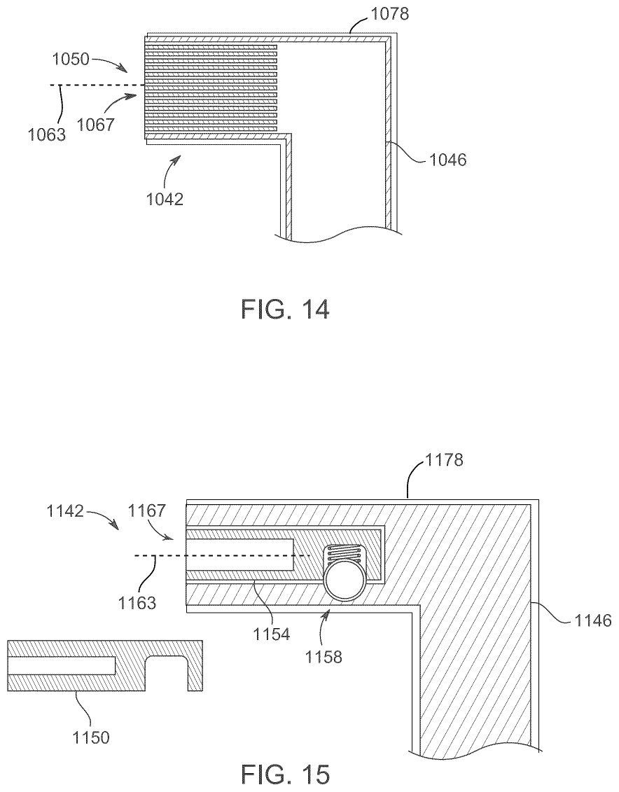

FIG. 15 illustrates another universal tip 1142 that can be coupled to each of the electrical leads 14 to accommodate different sized terminals 34, 38. The universal tip 1142 includes a main body 1146 that is electrically connected to one of the electrical leads 14, a first contact 1150 removably coupled to the main body 1146, and a second contact 1154 removably coupled to the main body 1146. A similar universal tip may also be coupled to the other electrical lead 14. The universal tip 1142 further includes an opening 1167 that receives the terminals 34, 38. The opening 1167 defines an axis 1163, along which the terminals 34, 38 pass. The opening 1167 is also configured to receive the first contact 1150 and the second contact 1154. The opening 1167 is a first size when the first contact 1150 is received within the opening 1167 and changes to a second size that is larger than the first size when the second contact 1154 is received within the opening 1167. The first contact 1150 accommodates the 4.0 millimeter terminals 34, 38, while the second contact 1154 accommodates the 4.7 millimeter terminals 34, 38. A detent mechanism 1158 (e.g., spring and ball catch) enables a quick-disconnect between the contacts 1150, 1154 and the main body 1146. The contacts 1150, 1154 are configured to slide in or out of the main body 1146 along the axis 1163. When a user desires the first contact 1150, the second contact 1154 is pulled from the main body 1146 along the axis 1163 so the first contact 1150 can be inserted into the main body 1146 along the axis 1163, and vice versa for the second contact 1154. The universal tip 1142 also includes an outer coating 1178 that is composed of an electrically insulative material and encases the main body 1146. The first and second contacts 1150, 1154 are composed of brass, while in other embodiments, the first and second contacts 1150, 1154 may alternatively be composed of other suitable electrically conductive materials.

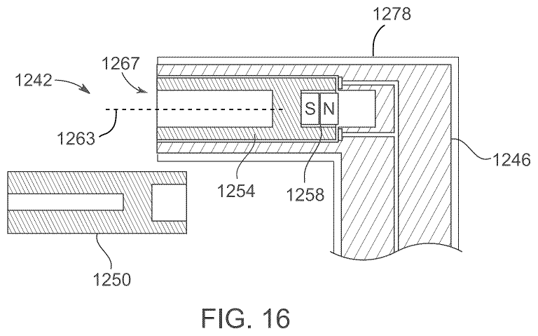

FIG. 16 illustrates another universal tip 1242 that can be coupled to each of the electrical leads 14 to accommodate different sized terminals 34, 38. The universal tip 1242 includes a main body 1246 that is electrically connected to one of the electrical leads 14, a first contact 1250 removably coupled to the main body 1246, and a second contact 1254 removably coupled to the main body 1246. A similar universal tip may also be coupled to the other electrical lead 14. The universal tip 1242 further includes an opening 1267 that receives the terminals 34, 38. The opening 1267 defines an axis 1263, along which the terminals 34, 38 pass. The opening 1267 is also configured to receive the first contact 1250 and the second contact 1254. The opening 1267 is a first size when the first contact 1250 is received within the opening 1267 and changes to a second size that is larger than the first size when the second contact 1254 is received within the opening 1267. The first contact 1250 accommodates the 4.0 millimeter terminals 34, 38, while the second contactor 1254 accommodates the 4.7 millimeter terminals 34, 38. A magnet 1258 (e.g., earth magnet, electromagnet, etc.) enables a quick-disconnect between the contacts 1250, 1254 and the main body 1246. The contacts 1250, 1254 are configured to slide in or out of the main body 1246 along the axis 1263. When a user desires the first contact 1250, the second contact 1254 is pulled from the main body 1246 along the axis 1263 so the first contact 1250 can be inserted into the main body 1246 along the axis 1263, and vice versa for the second contact 1254. The universal tip 1242 also includes an outer coating 1278 that is composed of an electrically insulative material and encases the main body 1246. The first and second contacts 1250, 1254 are composed of brass, while in other embodiments, the first and second contacts 1250, 1254 may alternatively be composed of other suitable electrically conductive materials.

Various aspects of the invention are set forth in the following claims.

What is claimed is:

1. A universal tip for an electrofusion tool, the universal tip comprising:
a main body configured to be electrically connected to an electrical lead of the electrofusion tool; and
a contact supported by the main body and capable of transferring a voltage from the electrofusion tool to a pipe fitting, the contact being adjustable between a first configuration, in which the contact is configured to engage a first terminal having a first size, and a second configuration, in which the contact is configured to engage a second terminal having a second size that is different than the first size.

2. The universal tip of claim 1, wherein the contact defines an opening, wherein in the first configuration, the opening has a first size, and wherein in the second configuration, the opening has a second size that is larger than the first size.

3. The universal tip of claim 2, wherein the opening defines an axis along which the first terminal or the second terminal is received into the opening.

4. The universal tip of claim 3, further comprising a collar disposed around the contact and movable along the axis between an extended position, in which the collar exerts a force on the contact to move the contact radially inward toward the axis to the first size, and a retracted position, in which the contact rebounds radially outward away from the axis to the second size.

5. The universal tip of claim 4, wherein collar includes a cam surface that interfaces with a corresponding cam surface of the contact to move the contact radially inward and radially outward in response to the cam surface of the collar sliding against the cam surface of the contact between the extended position and the retracted position.

6. The universal tip of claim 4, further comprising a spring that biases the collar toward the extended position.

7. The universal tip of claim 3, further comprising an elastomeric sleeve that is disposed around the contact, wherein the elastomeric sleeve exerts a force on the contact to move the contact radially inward toward the axis to the first size.

8. The universal tip of claim 7, wherein the contact includes a series of arcuate plates that are biased radially inward via the elastomeric sleeve.

9. The universal tip of claim 3, wherein the contact includes a series of arcuate plates that are biased radially inward toward the axis to the first size via a torsional spring, wherein the universal tip further comprises a handle portion that is manipulated to move the series of arcuate plates radially outward away from the axis to the second size against bias of the torsional spring.

10. The universal tip of claim 3, further comprising a leaf spring that biases a portion of the contact toward the axis to the first size.

11. The universal tip of claim 3, wherein the contact includes a first barrel and a second barrel, and wherein the first barrel is movable relative to the second barrel along the axis between an extended position, in which the first barrel engages the first terminal, and a retracted position, in which the second barrel engages the second terminal.

12. The universal tip of claim 11, wherein the first barrel is biased to the extended position via a spring, and wherein the first barrel is moved to the retracted position against the bias of the spring via the second terminal moving along the axis to engage the second barrel.

13. The universal tip of claim 3, wherein the contact includes a plurality of pins that are disposed throughout the opening, wherein a first amount of the plurality of pins is moved inward relative to the main body along the axis when the opening receives the first terminal and a second amount of the plurality of pins is moved inward relative to the main body along the axis when the opening receives the second terminal, and wherein the second amount is greater than the first amount.

14. The universal tip of claim 1, wherein the contact includes a first contact portion and a second contact portion, wherein in the first configuration, the first contact portion is positioned to engage the first terminal, and wherein in the second configuration, the second contact portion is configured to engage the second terminal.

15. The universal tip of claim 14, wherein the main body includes a threaded aperture to which the contact is threadably connected, wherein the second contact portion is disposed within the main body when the contact is in the first configuration, and wherein the first contact portion is disposed within the main body when the contact is in the second configuration.

16. The universal tip of claim 14, wherein at least a portion of the main body is rotatable relative to the electrical lead via a pivot joint, such that the first contact portion is rotated to align with the first terminal in the first configuration and the second contact portion is rotated to align with the second terminal in the second configuration.

17. The universal tip of claim 1, wherein the contact is one of a set of contacts including a first contact and a second contact, wherein in the first configuration, the first contact is supported by the main body and configured to engage the first terminal, and wherein in the second configuration, the second contact is supported by the main body and configured to engage the second terminal.

18. The universal tip of claim 17, wherein the first contact and the second contact are separately maintained in the main body via a detent mechanism.

19. The universal tip of claim 17, wherein the first contact and the second contact are separately maintained in the main body via a magnet.

20. The universal tip of claim 1, wherein the contact is composed of brass.

21. An electrofusion tool comprising:
a power module;
a pair of electrical leads electrically coupled to the power module; and
the universal tip of claim 1 coupled to one of the pair of electrical leads.

22. The electrofusion tool of claim 21, wherein the power module includes a battery connector configured to receive a battery pack.

23. The electrofusion tool of claim 22, further comprising the battery pack, wherein the battery pack includes a microcontroller that monitors a state of charge, a temperature, or both of the battery pack.

24. The electrofusion tool of claim 21, further comprising a scanner configured to scan a barcode on the pipe fitting.
